(19) United States
(12) Patent Application Publication
(10) Pub. No.: US 2019/0066232 A1
(43) Pub. Date: Feb. 28, 2019

(54) SYSTEMS AND METHODS FOR GENERATING SOCIAL MEDIA POSTS BASED ON SHOPPING ACTIVITY

(71) Applicant: Walmart Apollo, LLC, Bentonville, AR (US)

(72) Inventors: Richard M. Blair, II, Bentonville, AR (US); Steven J. Lewis, Bentonville, AR (US); Anthony G. Wind, III, Gravette, AR (US)

(21) Appl. No.: 16/115,928

(22) Filed: Aug. 29, 2018

Related U.S. Application Data
(60) Provisional application No. 62/552,665, filed on Aug. 31, 2017.

(51) Int. Cl. G06Q 50/00; G06Q 30/06; G06K 7/10; G06K 19/07

(52) U.S. Cl. CPC G06Q 50/01; G06K 19/0723; G06K 7/10386; G06Q 30/0609

(57) ABSTRACT

In some embodiments, apparatuses, systems, and methods are provided herein useful to generating social media posts for customers shopping in a retail shopping facility. In some embodiments, a system comprises a plurality of RFID tags, wherein the plurality of RFID tags is associated with a product in the retail shopping facility, a mobile device, wherein the mobile device includes an RFID reader, and a control circuit, wherein the control circuit is configured to determine an identity of a customer, receive, from the RFID reader, the signals from the plurality of RFID tags, determine, based on the signals from the plurality of RFID tags, a selected product, wherein the customer has chosen the selected product, determine, product information for the selected product, generate, based on the product information for the selected product and the identity of the customer, a social media post, and transmit, for publication, the social media post.

### CROSS-REFERENCE TO RELATED APPLICATION

This application claims the benefit of U.S. Provisional Application No. 62/552,665, filed Aug. 31, 2017, which is incorporated by reference in its entirety herein.

### TECHNICAL FIELD

This invention relates generally to retail shopping facilities and, more specifically, to using social media in conjunction with shopping in a retail shopping facility.

### BACKGROUND

Over the last several years, social media has become an important part of many people's lives. Many people like to share content, such as images, stories, etc. with their friends and publishing social media posts on social media platforms provides a convenient way to do so. Oftentimes this content is related to activities in which a person is partaking. For example, a person may like to share content via a social media post while shopping. While people enjoy sharing on various social media platforms, it can be difficult and/or time consuming to share content with family and friends via social media posts. For example, if a person is performing a task in which he or she is using his or her hands, he or she may find it difficult or cumbersome to use his or her mobile device to create a social media post and share the social media post while performing that task. Additionally, if the he or she would like to post content as rapidly as he or she performs a task, he or she may find it difficult to create and share social media posts as quickly as he or she would like.

### BRIEF DESCRIPTION OF THE DRAWINGS

Disclosed herein are embodiments of systems, apparatuses, and methods pertaining to generating social media posts for customers shopping in a retail shopping facility. This description includes drawings, wherein:

FIG. 1A depicts a customer 104 shopping in a retail shopping facility 102, according to some embodiments;

FIG. 1B depicts a web browser 112 presenting a shopping social media post 116 generated based on a user shopping in a retail shopping facility, according to some embodiments;

FIG. 2 is a block diagram depicting a system 200 for generating social media posts for customers shopping in a retail shopping facility, according to some embodiments; and

FIG. 3 is a flow diagram depicting example operations for generating social media posts for customers shopping in a retail shopping facility, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to generating social media posts for customer shopping in a retail shopping facility. In some embodiments, a system comprises a plurality of RFID tags, wherein each of the plurality of RFID tags is associated with a product in the retail shopping facility, a mobile device, wherein the mobile device includes an RFID reader configured to receive signals from the plurality of RFID tags, and a control circuit, wherein the control circuit is configured to determine an identity of a customer, receive, from the RFID reader, the signals from the plurality of RFID tags, determine, based on the signals from the plurality of RFID tags, a selected product, wherein the customer has chosen the selected product, determine, based on an RFID tag associated with the selected product, product information for the selected product, generate, based on the product information for the selected product and the identity of the customer, a social media post, and transmit, for publication, the social media post.

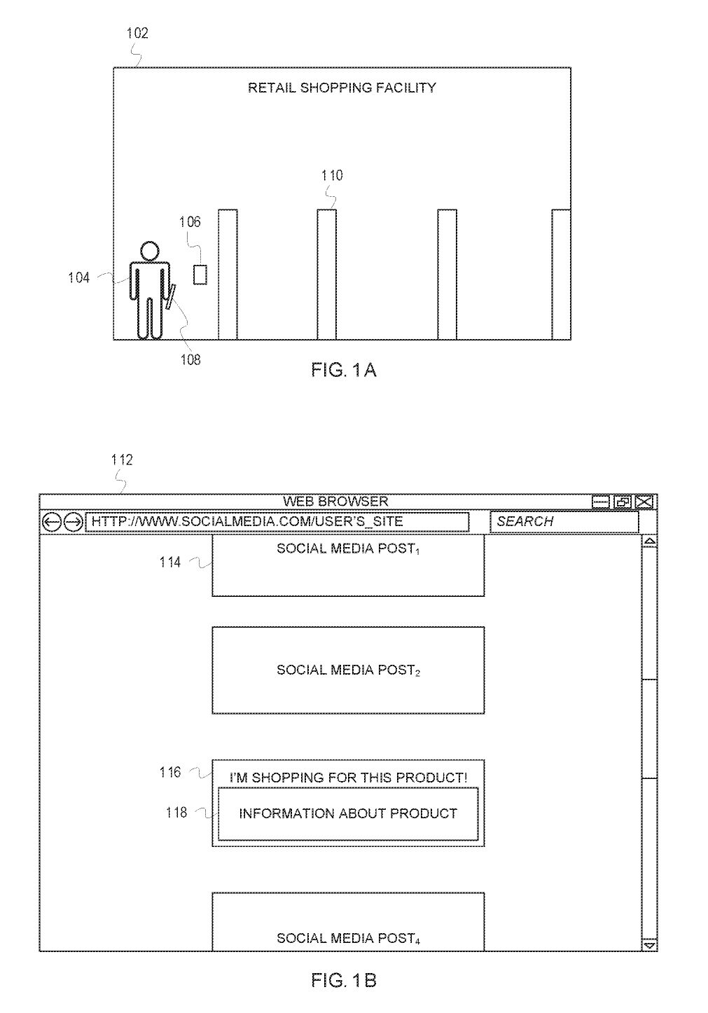

As previously discussed, people like to share content on social media platforms. This content is shared via social media posts. The social media posts can contain text, images, links (e.g., URLs), interactive features (e.g., polls, questionnaires, etc.), etc. Frequently, users share (i.e., publish) social media posts related to what they are doing. For example, a user might share a picture and caption while hiking, or a poll asking his or her friends which of a provided list of items he or she should eat for dinner. For users who like to share frequently, the amount of time and effort exerted to create and publish social media posts can be significant. In some embodiments, the systems, methods, and apparatuses described herein seek to minimize this burden by automatically creating, and in some instances publishing, social media posts on behalf of a user. Specifically, the systems, methods, and apparatuses described herein can be used while a customer is shopping in a retail shopping facility. For example, the customer's mobile device (e.g., smartphone, tablet, computer, etc.) can automatically generate social media posts related to products the customer is browsing. The social media post can include information about the product, the user, the retail shopping facility, etc. Because the social media post is automatically generated, it saves the customer time and effort. Additionally, automatically generating social media posts may allow customers to publish social media posts more rapidly. The discussion of FIGS. 1A and 1B provide an overview of such a system.

FIG. 1A depicts a customer 104 shopping in a retail shopping facility 102, according to some embodiments. The retail shopping facility 102 includes product display units 110 that present products to customers for sale. In FIG. 1A, a customer 104 is browsing the retail shopping facility 102 and carrying a mobile device 108. As the customer 104 selects products, the mobile device 108 detects the customer's 104 selection of the product. As depicted in FIG. 1A, the customer 104 has chosen a selected product 106. The mobile device 108 determines that the customer 104 has chosen the selected product 106.

In some embodiments, the mobile device 108 determines that the customer 104 has chosen the selected product 106 based on radio frequency identification (RFID) signals. In such embodiments, the products (as well as the selected product 106) have associated RFID tags. For example, the RFID tags can be affixed to the products, affixed to product packaging, incorporated with products, incorporated with product packaging, etc. The mobile device 108 includes an RFID reader and reads the RFID tags that are associated with the products.

After identifying the selected product 106, the mobile device 108 generates a social media post. The social media post can include information about the selected product 106, the customer 104, the retail shopping facility 102, external information, etc. For example, the social media post can include a manufacturer of the selected product 106, a color of the selected product 106, a type of the selected product 106, a cost of the selected product 106, a material of the selected product 106, a size of the selected product 106, a retailer of the selected product 106, a location of the retail shopping facility 102, a location of the customer 104, timing information, location information, timestamp information, accelerometer information, mobile device 108 software information, information about what other information the customer 104 is accessing via the mobile device 108, information about other purchasers (e.g., family and friends), etc. The social media post can be adapted for specific social media platforms or generic (i.e., adaptable by a social media platform to conform to the social media platform's constraints). In some embodiments, the social media post allows others to interact with the social media post. For example, the social media post can include a poll or questionnaire. The poll or questionnaire can be related to the selected product 106, the retail shopping facility 102, the customer 104, or any other suitable topic. In some embodiments, the customer 104 can review the interaction with the social media post. For example, the customer 104 can see the manner in which other people interacted with the social media post and/or the identities of the others interacting with the social media post.

In some embodiments, the customer 104 can set preferences for the social media posts. The preferences can be related to the frequency with which the mobile device 108 generates and/or publishes social media posts, the content of social media posts, the social media platforms to which the social media post is published, post automation, etc. For example, the customer 104 may set his or her preferences so that social media posts are generated automatically, but only published after he or she approves of the social media post. Further, in some embodiments, social media posts may not be generated and/or published without explicit approval of the customer 104. For example, the customer 104 may be required to opt in with respect to the generation of social media posts and/or the publication of social media posts. In this manner, the customer 104 has complete control over whether social media posts are generated and/or published and such generation and/or publication of social media posts will not occur without the customer's 104 explicit permission. As another example, the preferences may indicate that the social media posts include a manufacturer of the selected product 106, a color of the selected product 106, and an image of the selected product 106.

When the mobile device 108 generates the social media post, the mobile device 108 associates the social media post with the customer 104. In other words, the mobile device 108 identifies of the customer 104. In some embodiments, an application running on the mobile device 108 generates the social media posts. In such embodiments, the application can either receive identification information for the customer 104 and include the identification information in the social media post, or the application can transmit the social media post to a social media application that adds the identification information for the customer 104 to the social media post. In embodiments in which the application receives the identification information for the customer 104, the customer 104 can supply the identification information directly to the application (e.g., by providing his or her identification information or providing login credentials for a social media platform) or receive the identification information from a social media platform (e.g., from a social media application). In some embodiments, this information is not shared without the customer's 104 explicit permission.

After the mobile device 108 generates the social media post, the mobile device 108 transmits the social media post for publication. The mobile device 108 can transmit the social media post for publication via a push mechanism or a pull mechanism. That is, the mobile device 108 can proactively transmit the social media post to a social media platform, or wait for a request from a social media platform before transmitting the social media post.

While the discussion of FIG. 1A provides background information regarding the automatic generation of social media post while a customer shops in a retail shopping facility, the discussion of FIG. 1B provide additional detail regarding social media posts and social media platforms.

FIG. 1B depicts a web browser 112 presenting a shopping social media post 116 generated based on a customer shopping in a retail shopping facility, according to some embodiments. The web browser 112 can be a computer-based application or a mobile application. The web browser 112 presents websites for social media platforms. As depicted in FIG. 1B, the social media platform includes a plurality of social media posts 114. One of the social media posts 114 (i.e., a shopping social media post 116) was generated automatically while a customer was shopping. The shopping social media post 116 can include information about products 118 for which the customer is shopping, information about the customer, information about the retailer, etc.

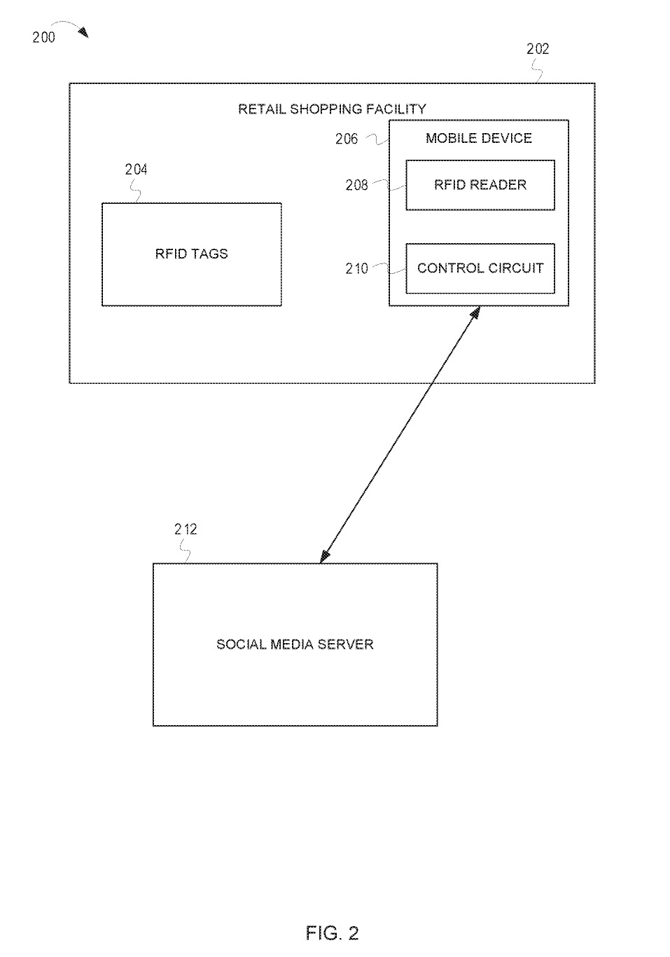

While the discussion of FIGS. 1A and 1B provide background regarding a system for automatically generating social media post and publishing social media post, the discussion of FIG. 2 provides additional details regarding such a system.

FIG. 2 is a block diagram depicting a system 200 for generating social media posts for customers shopping in a retail shopping facility, according to some embodiments. The system 200 includes a retail shopping facility 202, RFID tags 204, a mobile device 206, and a social media server 212. The retail shopping facility includes a number of products offered for sale. The RFID tags 204 are associated with the products. The RFID tags 204 can be affixed to the products or packaging of the products, or incorporated within the products or the packaging of the products.

The mobile device 206 includes a control circuit 210. The control circuit 210 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 210 is configured (for example, by using corresponding programming as will be well understood by those skilled in the art) to carry out one or more of the steps, actions, and/or functions described herein.

By one optional approach the control circuit 210 operably couples to a memory. The memory may be integral to the control circuit 210 or can be physically discrete (in whole or in part) from the control circuit 210 as desired. This memory can also be local with respect to the control circuit 210 (where, for example, both share a common circuit board, chassis, power supply, and/or housing) or can be partially or wholly remote with respect to the control circuit 210 (where, for example, the memory is physically located in another facility, metropolitan area, or even country as compared to the control circuit 210).

This memory can serve, for example, to non-transitorily store the computer instructions that, when executed by the control circuit 210, cause the control circuit 210 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The mobile device 206 also includes and RFID reader 208. The RFID reader 208 is configured to receive signals (i.e., RFID signals) from the RFID tags 204. As the customers browses products in the retail shopping facility 202, the RFID reader 208 receives the signals. The signals can include identifiers of the RFID tags 204. The control circuit 210 receives the RFID signals from the RFID reader 208.

When the customer chooses a product, the control circuit 210 determines the product that the customer has chosen (i.e., the selected product). The control circuit 210 determines the selected product based on the RFID signals. For example, the control circuit 210 can determine the selected product based on received signal strength indicators (RSSI) values of the RFID signals. For example, assume that the customer is standing near a product display unit presenting a number of pairs of jeans. If the customer is stationary relative to the pairs of jeans, the RSSI values of the signals received from the RFID tags 204 associated with the jeans will remain fairly constant. Even if the customer is not stationary relative to the pairs of jeans, the RSSI values for the signal received from the RFID tags 204 associated with the pairs of jeans will change in a similar manner. When the customer selects a pair of jeans, the RSSI value for the signal from the RFID tag associated with the selected pair of jeans will change differently than the RFID tags 204 associated with the other pairs of jeans. Specifically, as the customer brings the selected pair of jeans toward him or herself (i.e., away from the product display unit), the RSSI value of the received from the RFID tag 204 associated with the selected pair of jeans will increase. The control circuit 210 can determine that the customer has chosen the selected product based on this relative change in RSSI value for the selected product.

After determining the selected product, the control circuit 210 generates a social media post. The social media post can include information about the selected product and the user. For example, the social media post can indicate that the customer is considering purchasing the selected product. Additionally, in some embodiments, the social media post can include an interactive component that allows other people to interact with the social media post. For example, the social media post can include a poll. The poll can request input from other users of the social media platform, such as contacts or friends of the customer, or the public as a whole. The input requested may be for a comment on the social media post, to express a like for the social media post, to express a dislike for the social media post, to cast a vote on the social media post, and to share the social media post.

After the control circuit 210 has generated the social media post, the control circuit 210 transmits the social media post for publication. For example, the control circuit can transmit the social media post via a transmitter or transceiver of the mobile device 206 to the social media server 212 for publication by the social media server 212.

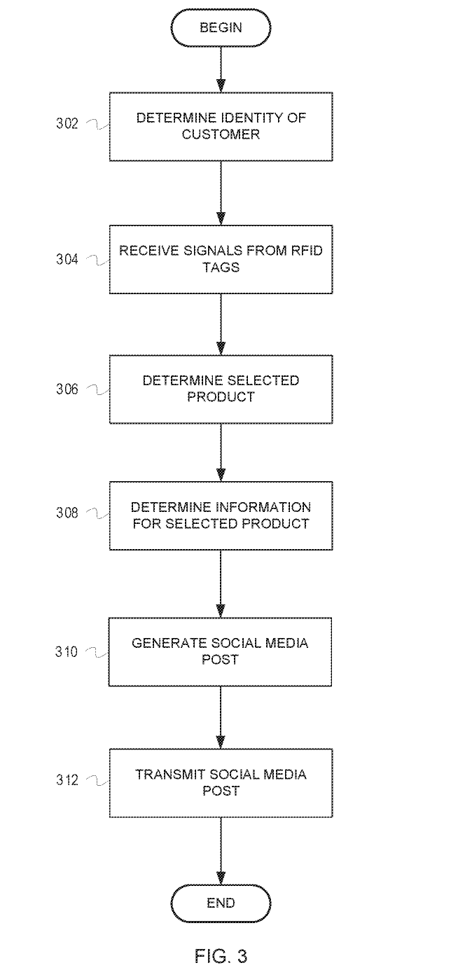

While the discussion of FIG. 2 provides additional details regarding a system for automatically generating social media posts while a customer shops in a retail shopping facility, the discussion of FIG. 3 provides example operations for automatically generating a social media post as a customer shops in a retail shipping facility.

FIG. 3 is a flow diagram depicting example operations for generating social media posts for customers shopping in a retail shopping facility, according to some embodiments. The flow begins at block 302.

At block 302, an identity of a customer is determined. For example, a control circuit can determine the identity of the customer. The control circuit can be part of a mobile device that the customer carries while the customer is shopping in the retail shopping facility. The control circuit can determine the identity of the customer explicitly or implicitly. For example, in embodiments where the control circuit determines the identity of the customer explicitly, the customer may have provided identification information directly to an application for generating social media posts (e.g., social media platform credentials). Alternatively, in embodiments in which the control circuit determines the identity of the customer implicitly, the control circuit may pass the generated social media post to a social media application executing on the mobile device, at which point the identity of the customer is determined. In either case, the identity of the customer may not be determined unless and until explicit permission is received from the customer. The flow continues at block 304.

At block 304, signals are received from RFID tags. For example, the mobile device can receive the RFID signals from an RFID reader incorporated or associated with the mobile device. The RFID tags are associated with products in the retail shopping facility. For example, the RFID tags can be affixed to or incorporated with the products or packaging for the products. As the customer travels through the retail shopping facility, the mobile device receives the RFID signals. The flow continues at block 306.

At block 306, a selected product is determined. For example, the control circuit can determine the selected product. The selected product is a product from the retail shopping facility chosen by the customer. In some embodiments, the control circuit determines the selected product based on the RFID signals. Specifically, the control circuit determines the selected product based on RSSI values for the RFID tags. As the customer chooses the selected product (e.g., removes the selected product from a product display unit, places the selected product in his or her cart or basket, moves away from the product display unit with the selected product, etc.), the RSSI value for the RFID signal from the RFID tag associated with the selected product changes relative to RSSI values of other RFID tags. For example, if the customer has his or her mobile device in his or her pocket, chooses the selected product, then walks away from the product display unit with the selected product, the RSSI value for RFID signals from the RFID tag associated with the selected product will remain fairly content (e.g., −80 dBm) while the RSSI values from RFID tags associated with other products on the product display unit will continue to decrease (e.g., −70 dBm, −60 dBm, −45 dBm . . . ). The flow continues at block 308.

At block 308, information for the selected product is determined. For example, the control circuit can determine the information about the selected product. The information about the selected product can include a manufacturer of the selected product, a color of the selected product, a type of the selected product, a cost of the selected product, a material of the selected product, a size of the selected product, and a retailer of the selected product, etc. The control circuit determines the information about the selected product based on the RFID tag associated with the selected product. For example, the RFID tag associated with the selected product can include a unique identifier. The unique identifier identifies the selected product. In some embodiments, the control circuit determines the information about the selected product by looking up the unique identifier in a database, from a website (e.g., a website associated with a manufacturer or retailer of the selected product), etc. The flow continues at block 310.

At block 310, a social media post is generated. For example, the control circuit can generate the social media post. The social media post can include information about the selected product, the customer, the retail shopping facility, external information, etc. For example, the social media post can include a manufacturer of the selected product, a color of the selected product, a type of the selected product, a cost of the selected product, a material of the selected product, a size of the selected product, a retailer of the selected product, a location of the retail shopping facility, a location of the customer, timing information, location information, timestamp information, accelerometer information, mobile device software information, information about what other information the customer is accessing via the mobile device 108, information about other purchasers (e.g., family and friends), etc. Additionally, the social media post can be generated based on customer preferences. For example, the customer preferences can be related to the frequency with which the mobile device generates and/or publishes social media posts, the content of social media posts, the social media platforms to which the social media post is published, post automation, etc. The flow continues at block 312.

At block 312, the social media post is transmitted for publication. For example, the control circuit can transmit the social media post for publication. In some embodiments, the control circuit transmits the social media post to a social media application running on the mobile device for publication by the social media application. In other embodiments, the control circuit transmits the social media post directly to a server associated with a social media platform. Additionally, how and when the control circuit transmits the social media post for publication can be controlled by the customer preferences. For example, the recipient of the social media post (e.g., a social media application or a server), or whether customer approval of the social media post is needed before transmission can be controlled by the customer preferences.

In some embodiments, a system comprises a plurality of RFID tags, wherein each of the plurality of RFID tags is associated with a product in the retail shopping facility, a mobile device, wherein the mobile device includes an RFID reader configured to receive signals from the plurality of RFID tags, and a control circuit, wherein the control circuit is configured to determine an identity of a customer, receive, from the RFID reader, the signals from the plurality of RFID tags, determine, based on the signals from the plurality of RFID tags, a selected product, wherein the customer has chosen the selected product, determine, based on an RFID tag associated with the selected product, product information for the selected product, generate, based on the product information for the selected product and the identity of the customer, a social media post, and transmit, for publication, the social media post.

In some embodiments, an apparatus and a corresponding method performed by the apparatus comprises determining an identity of a customer, receiving, from an RFID reader of a mobile device, signals from a plurality of RFID tags, wherein each of the plurality of RFID tags is associated with a product in the retail shopping facility, determining, based on the signals from the plurality of RFID tags, a selected product, wherein a customer has chosen the selected product, determining, based on an RFID tag associated with the selected product, product information for the selected product, generating, based on the product information for the selected product and the identity of the customer, a social media post, and transmitting, for publication, the social media post.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for generating social media posts for customers shopping in a retail shopping facility, the system comprising:
a plurality of RFID tags, wherein each of the plurality of RFID tags is associated with a product in the retail shopping facility;
a mobile device, wherein the mobile device includes:
an RFID reader, and wherein the RFID reader is configured to receive signals from the plurality of RFID tags; and
a control circuit, wherein the control circuit is configured to:
determine an identity of a customer;
receive, from the RFID reader, the signals from the plurality of RFID tags;
determine, based on the signals from the plurality of RFID tags, a selected product, wherein the customer has chosen the selected product;
determine, based on an RFID tag associated with the selected product, product information for the selected product;
generate, based on the product information for the selected product and the identity of the customer, a social media post; and
transmit, for publication, the social media post.

2. The system of claim 1, wherein the information for the selected product includes one or more of a manufacturer of the selected product, a color of the selected product, a type of the selected product, a cost of the selected product, a material of the selected product, a size of the selected product, and a retailer of the selected product.

3. The system of claim 1, wherein the control circuit determines the selected product based on a received signal strength indicator (RSSI) of a signal from the RFID tag associated with the selected product.

4. The system of claim 1, wherein the control circuit is further configured to:
determine, based on data from the mobile device, external information, wherein the social media post includes the external information.

5. The system of claim 4, wherein the external information includes one or more of timing information, location information, timestamp information, accelerometer information, and mobile device software information.

6. The system of claim 1, wherein the social media post allows others to interact with the social media post.

7. The system of claim 6, wherein the others can interact with the social media post via one or more of commenting on the social media post, expressing a like for the social media post, expressing a dislike for the social media post, voting on the social media post, and sharing the social media post.

8. The system of claim 1, wherein the social media post includes identifiers, and wherein the identifiers indicate one or more of a retailer and a manufacturer.

9. The system of claim 1, wherein the social media post is generated only after permission is received from the customer.

10. The system of claim 1, wherein the social media post is generated based on customer preferences, and wherein the customer preferences include one or more of post frequency preferences, post automation preferences, and post content preferences.

11. A method for automatically generating social media posts for customers shopping in a retail shopping facility, the method comprising:
determining an identity of a customer;
receiving, from a radio frequency identification (RFID) reader of a mobile device, signals from a plurality of RFID tags, wherein each of the plurality of RFID tags is associated with a product in the retail shopping facility;
determining, based on the signals from the plurality of RFID tags, a selected product, wherein a customer has chosen the selected product;
determining, based on an RFID tag associated with the selected product, product information for the selected product;
generating, based on the product information for the selected product and the identity of the customer, a social media post; and
transmitting, for publication, the social media post.

12. The method of claim 11, wherein the information for the selected product includes one or more of a manufacturer of the selected product, a color of the selected product, a type of the selected product, a cost of the selected product, a material of the selected product, a size of the selected product, and a retailer of the selected product.

13. The method of claim 11, wherein the determining the selected product is based on a received signal strength indicator (RSSI) of a signal from the RFID tag associated with the selected product.

14. The method of claim 11, further comprising:
determining, based on data from the mobile device, external information, wherein the external information is included in the social media post.

15. The method of claim 14, wherein the external information includes one or more of timing information, location information, timestamp information, accelerometer information, and mobile device software information.

16. The method of claim 11, wherein the social media post allows others to interact with the social media post.

17. The method of claim 16, wherein the others can interact with the social media post via one or more of commenting on the social media post, expressing a like for the social media post, expressing a dislike for the social media post, voting on the social media post, and sharing the social media post.

18. The method of claim 11, wherein the social media post includes identifiers, and wherein the identifiers indicate one or more of a retailer and a manufacturer.

19. The method of claim 11, wherein the social media post is generated only after permission is received from the customer.

20. The method of claim 11, wherein the social media post is generated based on customer preferences, and wherein the customer preferences include one or more of post frequency preferences, post automation preferences, and post content preferences.
